(19) United States
(12) Patent Application Publication
(10) Pub. No.: US 2006/0181714 A1
(43) Pub. Date: Aug. 17, 2006

(54) Method for processing multiwavelength interferometric imaging data

(75) Inventors: Michael J. Mater, Chelsea, MI (US); Jon Nisper, Grand Rapids, MI (US); Brett Allen Pawlanta, Grand Rapids, MI (US); Steven Clair Furtwangler, Caledonia, MI (US)

Correspondence Address: SCHOX PLC, 209 N. MAIN STREET #200, ANN ARBOR, MI, 48104, US

(73) Assignee: Coherix, Inc

(21) Appl. No.: 11/194,103

(22) Filed: Jul. 29, 2005

Related U.S. Application Data
(60) Provisional application No. 60/592,197, filed on Jul. 29, 2004.

(51) Int. Cl. G01B 11/02

(52) U.S. Cl. 356/512

(57) ABSTRACT

Data from an imaging interferometer producing at least three interferometric images of a surface of an object using at least three different frequencies of light illuminating the surface of the object is processed through a software data processing pipeline architecture which uses data processed by a plurality of data processors to generate a three dimensional surface profile of the surface of the object.

### CROSS REFERENCE TO RELATED APPLICATIONS

This application claims priority pursuant to 35 U.S.C. 119(e) to U.S. Provisional Application No. 60/592,197 Entitled Interferometry Control System, by inventors Jon Nisper, Brett Allen Pawlanta, Steven Clair Furtwangler filed Jul. 29, 2004, which application is incorporated herein by reference in its entirety including incorporated material.

### FIELD OF THE INVENTION

The field of the invention is the field of interferometric imaging.

### RELATED PATENTS AND APPLICATION

U.S. Pat. No. 5,907,404 by Marron, et al. entitled “Multiple wavelength image plane interferometry” issued May 25, 1999;

U.S. Pat. No. 5,926,277 by Marron, et al. entitled “Method and apparatus for three-dimensional imaging using laser illumination interferometry” issued Jul. 20, 1999;

U.S. patent application Ser. No. 10/893,052 filed Jul. 16, 2004 entitled “Object imaging system using changing frequency interferometry method” by Michael Mater;

U.S. patent application Ser. No. 10/349651 filed Jan. 23, 2003 entitled “Interferometry method based on changing frequency” by Michael Mater;

U.S. patent application filed Jul. 14, 2005 by inventors Jon Nisper, Mike Mater, Alex Klooster, Zhenhua Huang entitled “A method of combining holograms”;

U.S. patent application filed Jul. 29, 2005 by inventor Mike Mater entitled “A statistical method of generating a synthetic hologram from measured data”.

The above identified patents and patent applications are assigned to the assignee of the present invention and are incorporated herein by reference in their entirety including incorporated material.

### OBJECTS OF THE INVENTION

It is an object of the invention to produce a method, a system, and an apparatus for accurate interferometric surface profiling of objects which have surface variation large compared to the wavelength of visible light.

### SUMMARY OF THE INVENTION

An imaging interferometer produces interferometric images of a surface of an object using multiple frequencies of light, and the image data is processed by a plurality of data processors incorporated in a software data processing pipeline architecture, which uses data from the interferometric images to generate a three dimensional surface profile of the surface of the object.

### BRIEF DESCRIPTION OF THE DRAWINGS

FIG. 1 shows a sketch of a prior art Michelson interferometer.

FIG. 2 shows a sketch of a prior art imaging Michelson interferometer.

FIG. 3 shows the intensity recorded for a single pixel.

FIG. 4 shows a sketch of a representation of a data pipeline.

### DETAILED DESCRIPTION OF THE INVENTION

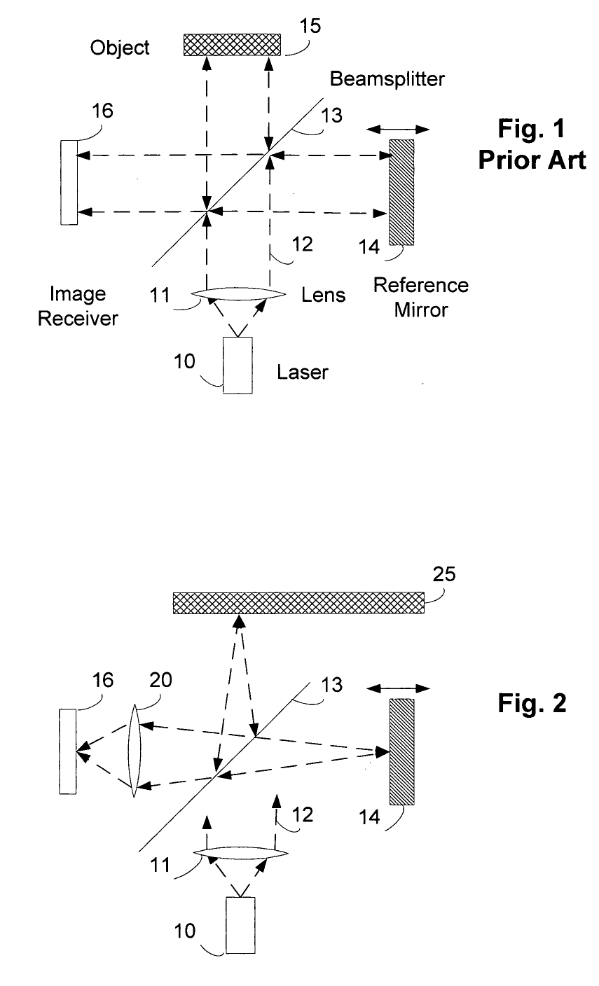

FIG. 1 shows a sketch of a prior art interferometer. The particular interferometer shown in FIG. 1 is conventionally called a Michelson interferometer, and has been used since the nineteenth century in optical experiments and measurements. A light source 10 produces light which is collimated by passing through a lens system 11 to produce a parallel beam of light 12 which passes to a beamsplitter 13. The beam of light 12 is partially reflected to a reference mirror 14 and partially transmitted to an object 15. Light reflected from the reference mirror 14 partially passes through the beamsplitter to an image receiver 16. Light reflected from the object is partially reflected from the beamsplitter 15 and is passed to the image receiver 16. The image receiver 16 may be film, or may be an electronic photodetector or CCD or CMOS array.

If both the reference mirror 14 and the object 15 are flat mirrors aligned perpendicular to the incoming light from beam 12, and the light path traversed by the light from the light source to the image receiver is identical, the light from both the reference mirror and the object mirror will be in phase, and the image receiver will show a uniformly bright image. Such devices were the bane of undergraduate optics students before the advent of lasers, since the distances had to be equal to within a small part of the wavelength of light and the mirrors had to be aligned within microradians. Even with the advent of lasers, such devices are subject to vibration, thermal drift of dimensions, shocks, etc.

However, the Michelson interferometer design of FIG. 1 is useful to explain the many different types of interferometers known in the art. In particular, suppose the reference mirror 14 is moved back and forth in the direction of the arrow in FIG. 1. As the reference mirror is moved, the phase of the light beam reflected from the reference mirror and measured at the image receiver 16 will change by 180 degrees with respect to the phase of the light reflected from the object 15 for every displacement of one quarter wavelength. The light from the two beams reflected from the object 15 and the reference mirror 14 will interfere constructively and destructively as the mirror moves through one quarter wavelength intervals. If the intensity on both the reference and object beam is equal, the intensity at the image receiver will be zero when the mirrors are positioned for maximum destructive interference. Very tiny displacements of one of the mirrors 14 or 15 can thus be measured.

FIG. 2 shows a sketch of an interferometer much like the interferometer of FIG. 1, except that diffusely reflecting objects 25 can be imaged on the image receiver 16 by using an additional lens 20. FIG. 2 shows also the problem solved by the method of the present invention, where the object 25 which is to be measured has a surface which is bigger than the field of view of the imaging optics.

Another inspection technique which is very useful is when the Michalson interferometer of FIG. 1 or FIG. 2 is used to compare the flatness of the surface of object 15 with the flatness of the reference mirror. As noted, if there is a difference in distance between the object mirror and the corresponding part of the reference mirror, the light from the two beams will interfere constructively or destructively and produce a pattern in the image receiver. Such patterns are generally called fringe patterns or interferograms, and can be likened to the lines on a topographic map. Such lines, as on a topographic map, can be interpreted as slopes, hills and depressions, The lines are separated in “height” by a half wavelength of the light from the light source 10.

One problem with the above description is that there are no numbers telling the difference between a depression and a hill, or in which direction the slope runs. However, if the reference mirror is moved, the lines will move, and, for example, the circles on a hill will shrink and a depression will expand for a particular direction of travel.

Interferometric techniques work very well for optical surface inspection to check whether the surface is flat, or curved to within a certain specification. However, for many surfaces which are rough on the scale of the wavelength of visible light, or have height variations or steep slopes, the “lines” of equal phase (or height) of the interferogram will be very close together. Any disturbances, noise, or other variation will make it difficult or impossible to “count” the fringes and thus measure the “height” of the various features. As an analogy, the result would be like trying to hike using a topographic map with lines every inch in height difference!

U.S. Pat. Nos. 5,907,404 and 5,926,277, assigned to the assignee of the present invention, show that a number of such interferograms taken with various phase delays in the reference beam and various wavelengths of the light source 10 may be recorded and computer analyzed to construct a “synthetic interferogram”, which is an interferogram which one would measure if one had a light source of much different wavelength from the wavelengths from the light source 10. Thus, the “lines” on the interferogram could show height differences of, say, 100 microns instead of 0.4 micron height differences, so the lines would be much further apart and much easier to keep track of. The advantage, of course, is that lasers of 200 micron wavelength are hard to find, and electronic imaging equipment for such wavelengths is even harder to find, and spatial resolution of such a detector, if available, could not possibly match the resolution of detectors for visible and near infra-red light.

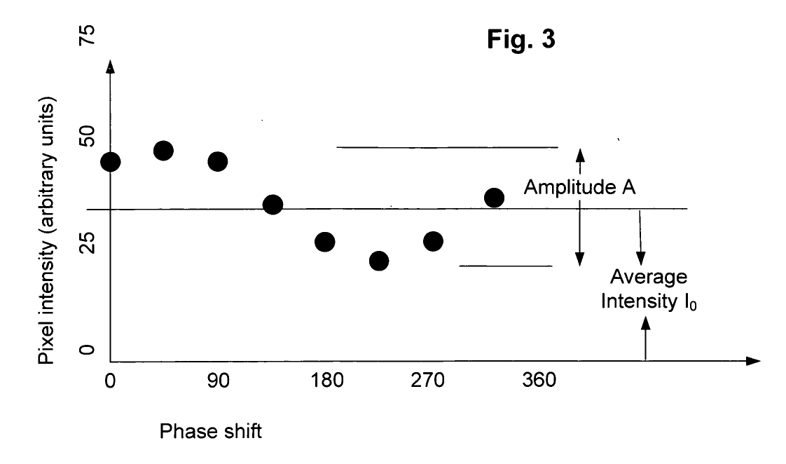

FIG. 3 shows the intensity recorded for a single pixel of the imaging device 16 as the reference mirror 14 is moved in steps perpendicular to the incident beam. The step distances can be converted to a phase shift of the reference beam measured at the image receiver 16. In a perfect world, the measurements would lie on a sinusoidal curve. If the intensity of the beams received from the object and the reference mirror were equal, the intensity would be zero when the two beams interfered destructively. For the usual case that the intensities in the two beams are not equal, the intensity of the interfering beams never reaches zero, and varies with an amplitude A about an average intensity I₀ which is related to the reflectivity of the object. The phase of the object beam at one pixel can be measured with respect to the phase at another pixel by inspecting the data shown by FIG. 3 for each pixel.

Manual inspection of results from a megapixel imaging device of course is difficult for humans, but easy for a computer programmed with a fast Fourier transform (FFT) program or other statistical analysis program. The FFT of a perfect sine wave gives a delta function telling the frequency of the wave, and in the case of a sine wave displaced from the origin also gives a “phase”, as well as the amplitude A and average intensity I₀. Since the “frequency” of the results from all the pixels is the same, the relative “phase” for each pixel can be recorded from sufficient measurements of pixel intensity as the reference mirror is moved to change the phase of the reference beam. The multiple measurements remove much of the “noise” which would complicate the interpretation of an interferogram taken with an object fixed with respect to the reference mirror, as the maximum height peak of the FFT is easily identified and lower height peaks introduced by noise are ignored. The recorded measurements of phase and amplitude are sometimes called a digital hologram. The phase, amplitude, or other measurements so recorded as images are called, for the purposes of this specification, as synthetic “phase images”, and can be printed out as a two dimensional image where brightness or color is directly related to phase, intensity, etc. I₀ can be printed out, and looks similar to the image which would be recorded in absence of the reference beam or a normal photographic or digital image of the object.

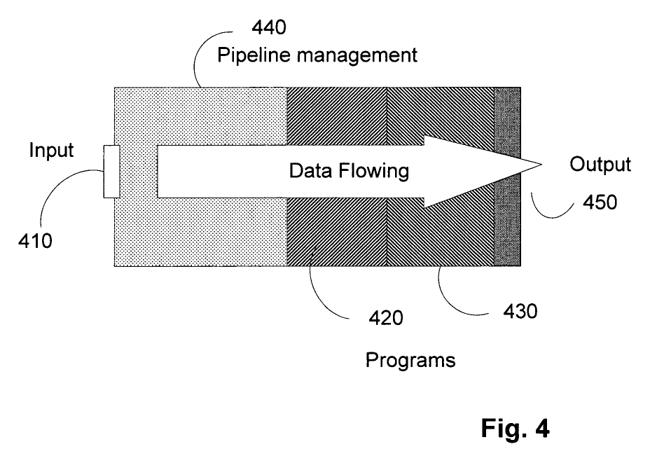

Requirements for higher resolution images of larger objects, as well as statistical treatment of the images to improve accuracy, place great demands on the computation systems. Since a large number of imaging systems may be located in one facility, the present invention teaches the use of a data pipeline architecture, shown schematically in FIG. 4, to process the data using multiple processors associated with each imaging system. Stand alone or other processors associated with other applications or services may also be called on for help in processing the data. Processors accessed over the internet may also be used. Data such as images and the associated identifiers and derivatives of the image data stream though the pipeline. This data is input at 410, is processed through a series of programs 420 and 430, which may be contained in multiple processors and which constitute the analysis pipeline. The data is output at 450 to the user or to other parts of the pipeline The core pipeline management software application 440 manages theses applications, and is responsible for directing the data to the applications in a secure manner, recording the application versions that are used, providing uniform error trapping, providing a quality assurance strategy, providing a standard recovery on failure, and providing a central metadata repository for tracking the jobs. Data provenance is recorded through the pipeline services.

The pipeline services provide a repository where the code that runs the core pipeline application will be obtained, as well as applications that can be fetched as the pipeline directs a specific (helper) application to run locally and which provide a workflow service that stores a representation of the workflow and the data provenance information as well as provides services where client viewers can attach to follow the progression of the workflow. The workflow service also provides the URL's for the discovery of available applications at various locations.

As an example of a data treatment carried out in multiple processors, the raw data from an image receiving device may be input to the pipeline, and the pipeline segments the image and sends part of the data to a number of processors, each of which is instructed to smooth the image, for example, by a weighted averaging procedure where the smoothed intensity of a given pixel is calculated by adding the intensity counts of the pixel to, say, half the intensity counts of the neighboring pixels and quarter the intensity counts of the four corner pixels. The a smoothed image is then obtained by combining the results from the segmented image, and passed to the next stage of the process.

The pipeline is responsible for deciding whether to scale the data according to the resources available. For example, a lower resolution image may be obtained by smoothing the original image data over more pixels, and replacing the original image with one having fewer pixels.

A particular advantage of the pipeline is obtained when the frequency and phase of the illuminating light for the interferometer is not known to the required accuracy. A statistical measure calculated from the pixel intensity data may be calculated and recalculated as the frequency or phase is changed, until a criterion is reached, and the corrected frequency and/or phase used in the final calculation of the surface profile.

Obviously, many modifications and variations of the present invention are possible in light of the above teachings. It is therefore to be understood that, within the scope of the appended claims, the invention may be practiced otherwise than as specifically described.

We claim:

1. A system, comprising:
a) an imaging interferometer, wherein the imaging interferometer produces at least three interferometric images of a surface of an object using at least three different frequencies of light illuminating the surface of the object;
b) a plurality of data processors; and
c) a software data processing pipeline architecture which uses data from the interferometric images processed by the plurality of data processors to generate a three dimensional surface profile of the surface of the object.

2. The system of claim 1, wherein the data processing pipeline architecture comprises at least one data input; a data output; a data path between the input and output; wherein at least a first one of the plurality of data processors accesses an output of at least a second one of the data processors execute a data processing task.

3. The system of claim 2, wherein the output of the second data processing module is a smoothed interferometric image.

4. The system of claim 1, wherein at least a first data processor is widely spaced apart from at least a second data processor.

5. The system of claim 4, wherein the first and the second data processors are in communication over the internet.

6. The system of claim 1, wherein at least one of the three interferometric images is segmented, and data from each segmentation is sent to different data processors of the plurality of data processors.

7. The system of claim 1, wherein the system scales the workload according to the available processors.

8. The system of claim 1, wherein the system uses a digital Fourier transform on intensity values measured for each of the at least three frequencies of light for each of a plurality of pixels of the at least three interferometric images.

9. The system of claim 1, wherein local processors directing interferometric image acquisition systems are reprogrammed over the internet.

10. The system of claim 1, wherein interferometric image acquisition system is recalibrated over the internet.

11. The system of claim 1, wherein an estimated value of the frequency of at least one of the at least three frequencies of light is corrected by an iteration procedure according to a statistical measure derived from the output of at least one of the plurality of data processors.

12. The system of claim 1, wherein an estimated value of the phase of the light of at least one of the at least three frequencies of light is corrected by an iteration procedure according to a statistical measure derived from the output of at least one of the plurality of data processors.
